(19) United States
(12) Patent Application Publication
(10) Pub. No.: US 2024/0279060 A1
(43) Pub. Date: Aug. 22, 2024

(54) METHOD FOR PRODUCING PURIFIED AQUEOUS HYDROGEN PEROXIDE SOLUTION

(71) Applicant: MITSUBISHI GAS CHEMICAL COMPANY, INC., Tokyo (JP)

(72) Inventors: Kohei SHIGETA, Kamisu-shi, Ibaraki (JP); Yasuhiro KUSHIDA, Niigata-shi, Niigata (JP)

(73) Assignee: MITSUBISHI GAS CHEMICAL COMPANY, INC., Tokyo (JP)

(21) Appl. No.: 18/570,142

(22) PCT Filed: Jun. 20, 2022
(86) PCT No.: PCT/JP2022/024484

§ 371 Date: Dec. 14, 2023

(30) Foreign Application Priority Data
Jun. 22, 2021 (JP) 2021-103228

(51) Int. Cl. C01B 15/013; B01D 61/02; B01D 69/02

(52) U.S. Cl. CPC C01B 15/013; B01D 61/025; B01D 69/02; B01D 2325/06; B01D 2325/20

(57) ABSTRACT

Provided is a method for producing aqueous hydrogen peroxide solution, the method capable of reducing impurities such as organic substances and preventing the occurrence of foaming and odor. The solution for the aforementioned problems is a method for producing a purified aqueous hydrogen peroxide solution, the method including a predetermined osmosis membrane treatment process of bringing a crude aqueous hydrogen peroxide solution containing impurities into contact with a reverse osmosis membrane. That is, the aforementioned problems are solved by a method for producing a purified aqueous hydrogen peroxide solution, in which a first integrated value that is the integrated value of the pressure and the linear velocity are adjusted so that the pressure of reverse osmosis membrane (MPaG) and the linear velocity of the aqueous hydrogen peroxide solution (m³/(m²·h)) is less than 0.15 in the osmosis membrane treatment process.

### TECHNICAL FIELD

The present invention relates to a method for producing a purified aqueous hydrogen peroxide solution, particularly, a method for producing a purified aqueous hydrogen peroxide solution, the method comprising an osmosis membrane treatment process using a reverse osmosis membrane (RO membrane).

### BACKGROUND ART

Since hydrogen peroxide has oxidizing power and strong bleaching/sterilizing effects, it is used as bleaching agents for paper, pulp, fibers, or the like, sterilizing agents, food additives. Furthermore, the amount of hydrogen peroxide used is increasing in the electronic industry, such as washing the surfaces of semiconductor substrates, chemically polishing the surfaces of copper alloys containing copper, tin, or the like, and etching electronic circuits.

The anthraquinone method is a common method for producing hydrogen peroxide, but aqueous hydrogen peroxide solutions produced by such a method using an organic solvent contains impurities such as organic substances derived from the organic solvent used. Further, foaming may occur during ultrasonic degassing during the production of aqueous hydrogen peroxide solutions using the anthraquinone method, and the odor characteristic of hydrogen peroxide may occur.

In view of the above, aqueous hydrogen peroxide solutions obtained by the anthraquinone method and the like have been purified. Examples of common methods for purifying aqueous hydrogen peroxide solutions include methods using distillation, cyclones, adsorption resins, ion exchange resins, reverse osmosis membranes, or the like (Patent Literature 1).

### CITATION LIST

### Patent Literature

Patent Literature 1: Japanese Patent Laid-Open No. 2000-302418

### SUMMARY

### Technical Problem

Even with conventional purification methods, there is a problem that it is not always possible to obtain an aqueous hydrogen peroxide solution having sufficiently desirable properties. That is, even in aqueous hydrogen peroxide solutions purified by conventional methods, they contain relatively large amounts of impurities such as organic substances, and the foaming and odor that occur during degassing cannot be sufficiently suppressed.

There is a need for a method for producing an aqueous hydrogen peroxide solution in which impurities such as organic substances are reduced, and foaming and odor do not occur.

### Solution to Problem

As a result of diligent studies in order to solve the above problems, the inventors have found that the quality of aqueous hydrogen peroxide solutions can be improved by adjusting the conditions in the treatment process of crude aqueous hydrogen peroxide solutions to be brought into contact with RO membranes.

The present invention includes the following aspects.

[1] A method for producing a purified aqueous hydrogen peroxide solution, the method comprising an osmosis membrane treatment process of bringing a crude aqueous hydrogen peroxide solution containing impurities into contact with a reverse osmosis membrane, wherein the pressure of the reverse osmosis membrane (MPaG) and the linear velocity of the aqueous hydrogen peroxide solution (m³/(m²·h)) are adjusted so that a first integrated value that is the integrated value of the pressure and the linear velocity is less than 0.15, in the osmosis membrane treatment process.
[2] The method according to [1] above, wherein the surface roughness average of the reverse osmosis membrane is 0.24 μm or more.
[3] The method according to [1] or [2] above, wherein the surface roughness average of the reverse osmosis membrane is 1.0 μm or less.
[4] The method according to any one of [1] to [3] above, wherein the weight ratio of oxygen/nitrogen on the surface of the reverse osmosis membrane is less than 40.
[5] The method according to any one of [1] to [4] above, further comprising: a roughness measurement step of measuring the surface roughness of the reverse osmosis membrane to be used in the osmosis membrane treatment process.
[6] The method according to any one of [1] to [5] above, wherein a second integrated value obtained by further multiplying the first integrated value by the viscosity (mPa·s) of the crude aqueous hydrogen peroxide solution in the osmosis membrane treatment process is less than 0.19.
[7] The method according to any one of [1] to [6] above, wherein the temperature of the crude aqueous hydrogen peroxide solution is 10 to 30° C. in the osmosis membrane treatment process.
[8] The method according to any one of [1] to [7] above, wherein a permeation ratio (%) defined by formula (1) below from permeated hydrogen peroxide (permeated aqueous hydrogen peroxide solution) that is an aqueous hydrogen peroxide solution in which the impurities are reduced and concentrated hydrogen peroxide that is an aqueous hydrogen peroxide solution which does not permeate through the reverse osmosis membrane and in which the impurities are concentrated to be obtained by the osmosis membrane treatment process is 80% or less:

Permeation ratio (%)=(mass of permeated hydrogen peroxide)/(mass of permeated hydrogen peroxide+concentrated hydrogen peroxide)×100 (1)

[9] The method according to [8] above, wherein the permeation ratio is 40% or less, and the temperature of the crude aqueous hydrogen peroxide solution in the osmosis membrane treatment process is 25° C. or less.
[10] The method according to [8] above, wherein the permeability is 60% or more, and the temperature of the crude aqueous hydrogen peroxide solution in the osmosis membrane treatment process is 15 to 35° C. or less.

### Advantageous Effects of Invention

According to the present invention, an aqueous hydrogen peroxide solution in which the content of impurities such as organic compounds can be reduced, and foaming and odor that may occur mainly in the process of producing hydrogen peroxide are suppressed can be produced.

### BRIEF DESCRIPTION OF DRAWINGS

FIG. 1 is a schematic view of a hydrogen peroxide purification system according to an aspect used for the method for producing a purified aqueous hydrogen peroxide solution of the present invention.

FIG. 2 is a graph showing the relationship between the product (first integrated value) of the pressure of the RO membrane and the linear velocity of the hydrogen peroxide solution during the purification process, and the amount of the organic substances (TC value) in the hydrogen peroxide solution after purification in the results of Examples and Comparative Examples.

FIG. 3 is a graph showing the relationship between the product (second integrated value) of the pressure of the RO membrane, the linear velocity of the hydrogen peroxide solution, and the viscosity of the hydrogen peroxide solution during the purification process, and the amount of the organic substances (TC value) in the hydrogen peroxide solution after purification in the results of Examples and Comparative Examples.

### DESCRIPTION OF EMBODIMENTS

An aspect of the present invention is a method for producing a purified aqueous hydrogen peroxide solution, the method comprising an osmosis membrane treatment process of bringing a crude aqueous hydrogen peroxide solution containing impurities into contact with a reverse osmosis membrane. The present invention relates to a method for producing a purified aqueous hydrogen peroxide solution in which the pressure (MPaG) of the reverse osmosis membrane and the linear velocity (m³/(m²·h)) of the aqueous hydrogen peroxide solution are adjusted so that a first integrated value that is the integrated value of the pressure and the linear velocity is less than 0.15 in the osmosis membrane treatment process. It is possible to obtain an aqueous hydrogen peroxide solution containing less impurities such as organic compounds while suppressing foaming and odor that may occur mainly in the process of producing hydrogen peroxide by such a method for producing a purified aqueous hydrogen peroxide solution.

Hereinafter, the method for producing a purified aqueous hydrogen peroxide solution of the present invention will be described further in detail.

### [Method for Producing Purified Aqueous Hydrogen Peroxide Solution]

The method for producing a purified aqueous hydrogen peroxide solution comprises an osmosis membrane treatment process of purifying a crude aqueous hydrogen peroxide solution. In the osmosis membrane treatment process, a reverse osmosis membrane (RO membrane) is used, and a purified aqueous hydrogen peroxide solution containing less impurities such as organic compounds than the crude aqueous hydrogen peroxide solution is obtained. That is, the crude aqueous hydrogen peroxide solution is purified by the osmosis membrane treatment process, and the purified aqueous hydrogen peroxide solution containing less impurities is produced.

### 1. Osmosis Membrane Treatment Process

### 1-1. Relationship Between Pressure of Reverse Osmosis Membrane and Linear Velocity of Crude Aqueous Hydrogen Peroxide Solution

In the osmosis membrane treatment process, a crude aqueous hydrogen peroxide solution is purified.

The crude aqueous hydrogen peroxide solution is an aqueous hydrogen peroxide solution that is not purified with an RO membrane, and the aqueous hydrogen peroxide solution may be produced by any technique such as the anthraquinone method, the alcohol oxidation method, the redox method, the direct method (direct oxidation method), and the electrolytic method. The crude aqueous hydrogen peroxide solution may contain one or both of organic impurities and inorganic impurities. The concentration of the hydrogen peroxide contained in the crude aqueous hydrogen peroxide solution is not specifically limited, but may be 20 to 90 wt %, 30 to 80 wt %, 35 to 70 wt %, or 40 to 60 wt %, for example.

In the osmosis membrane treatment process, the pressure of the reverse osmosis membrane, the linear velocity of the aqueous hydrogen peroxide solution, or the like is adjusted to a preferable range. Specifically, the pressure and the linear velocity are adjusted so that a first integrated value (MPaG·m³/(m²·h)) that is the integrated value of the pressure of the reverse osmosis membrane (MPaG) and the linear velocity of the aqueous hydrogen peroxide solution (m³/(m²·h)) is less than 0.15. The first integrated value (MPaG·m³/(m²·h)) is preferably 0.12 or less, more preferably 0.10 or less, further preferably 0.08 or less, particularly preferably 0.06 or less. The lower limit of the first integrated value (MPaG·m³/(m²·h)) is not particularly limited but is 0.01 or more, for example.

In this way, it is possible to obtain a purified aqueous hydrogen peroxide solution containing less impurities such as organic compounds by adjusting the range of the first integrated value that is a parameter related to the pressure applied to the reverse osmosis membrane and the linear velocity of the crude aqueous hydrogen peroxide solution to be treated in the purification process of the crude aqueous hydrogen peroxide solution.

In the osmosis membrane treatment process, a second integrated value, obtained by multiplying the viscosity (cP or mPa·s) of the crude aqueous hydrogen peroxide solution by the first integrated value (MPaG·m³/(m²·h)·cP; or MPaG·m³·cP/(m²·h) or (MPaG·m³/(m²·h)·mPa·s), is preferably less than 0.19. The second integrated value (MPaG·m³/(m²·h)·mPa·s) is preferably 0.17 or less, more preferably 0.15 or less, further preferably 0.13 or less, particularly preferably 0.10 or less. Further, the lower limit of the second integrated value (MPaG·m³/(m²·h)·mPa·s) is not particularly limited but is 0.01 or more, for example.

In this way, it is possible to obtain a purified aqueous hydrogen peroxide solution containing less impurities by adjusting the range of the second integrated value that is a parameter related to the pressure applied to the reverse osmosis membrane, the linear velocity of the crude aqueous hydrogen peroxide solution to be treated, and the viscosity in the purification process of the crude aqueous hydrogen peroxide solution.

The pressure (gauge pressure: MPaG) on the reverse osmosis membrane for purify the crude aqueous hydrogen peroxide solution in the osmosis membrane treatment process, that is, the pressure (MPaG) applied on the crude aqueous hydrogen peroxide solution to penetrate through the reverse osmosis membrane may be preferably 0.02 to 8.0, more preferably 0.10 to 6.5, further preferably 0.30 to 5.5, particularly preferably 0.40 to 4.7, 0.80 to 4.5, or 1.0 to 4.0.

Further, the gauge pressure (MPaG) in the osmosis membrane treatment process corresponds to the value obtained by subtracting 0.1 from the absolute pressure (MPaA (or MPa)). Therefore, the value related to the gauge pressure (MPaG) can be converted to the value of the absolute pressure (MPaA (or MPa)) by adding 0.1.

For example, a preferable range of the pressure of the reverse osmosis membrane defined by the gauge pressure may be preferably 0.12 to 8.1, more preferably 0.20 to 6.6, further preferably 0.40 to 5.6, particularly preferably 0.50 to 4.5, 0.90 to 4.6, or 1.1 to 4.1, as the absolute pressure (MPaA (or MPa)).

The linear velocity of the crude aqueous hydrogen peroxide solution (m³/(m²·h)) in the osmosis membrane treatment process is preferably 0.005 to 0.050, and the linear velocity (m³/(m²·h)) is more preferably 0.007 to 0.040, further preferably 0.010 to 0.030.

The flow rate (L/minute) of the crude aqueous hydrogen peroxide solution in the osmosis membrane treatment process is preferably 0.03 to 3.0, and the flow rate (L/minute) is more preferably 0.1 to 2.5, further preferably 0.3 to 2.0, particularly preferably 0.5 to 1.5.

In the osmosis membrane treatment process, as will be described in detail below, it is preferable to employ a reverse osmosis membrane in which the permeation flux of pure water under conditions at a temperature of 25° C. and an effective pressure of 2.0 MPa can be adjusted to less than 0.6 (m³/m²/day).

In the osmosis membrane treatment process, the viscosity (cP or mPa·s) of the crude aqueous hydrogen peroxide solution is preferably 0.05 to 3.0, and the viscosity (cP or mPa·s) is more preferably 0.1 to 2.7, further preferably 0.3 to 2.5, particularly preferably 0.5 to 2.0 or 0.9 to 1.5.

### 1-2. Temperature of Crude Aqueous Hydrogen Peroxide Solution

In the osmosis membrane treatment process, the temperature of the crude aqueous hydrogen peroxide solution to be treated is, for example, −20 to 40° C., preferably 5 to 25° C., and may be other temperature range. For example, the temperature range of the crude aqueous hydrogen peroxide solution to be treated may be 10 to 30° C., 12 to 27° C., 15 to 25° C., or the like.

Further, in the osmosis membrane treatment process, the range of the value obtained by dividing the pressure (MPaG) applied to the crude aqueous hydrogen peroxide solution by the temperature (° C.) of the crude aqueous hydrogen peroxide solution (MPaG/° C.) is preferably 0.01 to 0.50, and the value (MPaG/° C.) is more preferably 0.03 to 0.40, further preferably 0.05 to 0.35, particularly preferably 0.10 to 0.30.

### 1-3. Permeation Ratio

The permeation ratio (ratio of permeates; %) defined by formula (1) below related to the mass ratio of the permeated hydrogen peroxide that is an aqueous hydrogen peroxide solution in which impurities are reduced to the concentrated hydrogen peroxide that is an aqueous hydrogen peroxide solution which does not permeate through the reverse osmosis membrane and in which the impurities are concentrated to be obtained by the osmosis membrane treatment process may be preferably 80% or less, 85% or less, or 90% or less.

Permeation ratio (%)=(mass of permeated hydrogen peroxide)/(mass of permeated hydrogen peroxide+concentrated hydrogen peroxide)×100 (1)

The permeation ratio is more preferably 75% or less, further preferably 70% or less, particularly preferably 60% or less. Further, the permeation ratio is, for example, 20% or more, preferably 25% or more, or 35% or more. When the permeation ratio is large, although it is made possible to obtain a large amount of permeated hydrogen peroxide in a short time by the osmosis membrane treatment process, the operational load on each device in the purification system described below used for purifying the aqueous hydrogen peroxide solution also increases. Therefore, the value is preferably within the aforementioned predetermined range.

For removing the organic compounds efficiently, in the osmosis membrane treatment process, it tends to be preferable to keep the temperature of the aqueous hydrogen peroxide solution to be treated low when the permeation ratio is small. Therefore, it is preferable that the permeation ratio in formula (1) above is set to 40% or less, 35% or less, or 30% or less, and the temperature of the crude aqueous hydrogen peroxide solution in the osmosis membrane treatment process, that is, the liquid temperature is set to 25° C. or less or 20° C. or less, such as 5 to 25° C. or 10 to 20° C., for example.

Meanwhile, when the permeation ratio is large in the osmosis membrane treatment process, even if the temperature of the aqueous hydrogen peroxide solution to be treated is comparatively high, it tends to be preferable. Therefore, it is preferable that the permeation ratio in formula (1) above is set to 60% or more, 65% or more, or 70% or more, and the temperature of the crude aqueous hydrogen peroxide solution in the osmosis membrane treatment process, that is, the liquid temperature is set within a range such as 15 to 35° C. or 10 to 30° C., for example.

### 1-4. Impurities Contained in Crude Aqueous Hydrogen Peroxide Solution

Permeated hydrogen peroxide that is an aqueous hydrogen peroxide solution with reduced impurities of the crude aqueous hydrogen peroxide solution is obtained by the osmosis membrane treatment process, wherein the concentration of the impurities in the permeated hydrogen peroxide is preferably 20 mg/L or less. According to the method for producing a purified aqueous hydrogen peroxide solution of the present invention, permeated hydrogen peroxide substantially free from impurities can be efficiently produced, and the impurities concentration can be kept low as described above. The concentration of the impurities in the permeated hydrogen peroxide is more preferably 16 mg/L or less, further preferably 12 mg/L or less, particularly preferably 10 mg/L or less, or 8 mg/L or less.

The impurities of the crude aqueous hydrogen peroxide solution to be purified generally contain organic compounds generated in the production process of hydrogen peroxide, for example, by the anthraquinone method. Examples of such organic compounds include working solution compositions and their degraded products, when the crude aqueous hydrogen peroxide solution contains hydrogen peroxide produced, for example, by the anthraquinone method. Examples of the degraded products include non-polar solvent degraded products (such as benzaldehydes, benzoic acids, phenols, and benzyl alcohols), polar solvent degraded products (such as 2-ethylhexanol and 2-ethylhexanal), and anthraquinone degraded products (such as anthrone, oxyanthrone, tetrahydroxyanthrone, anthraquinone epoxide, and tetrahydroanthraquinone epoxide).

The impurities contained in the crude aqueous hydrogen peroxide solution may include inorganic compounds. Examples of the inorganic impurities include compounds derived from the catalysts by the anthraquinone method such as copper, zinc, chromium, palladium, rhodium, ruthenium, platinum, iron, nickel, aluminum, sodium, potassium, calcium, chlorine, sulfur, silica, and boron. These inorganic compounds may also be subjected to purification.

### 2. Reverse Osmosis Membrane (RO Membrane)

### 2-1. Form of Reverse Osmosis Membrane

The type of the reverse osmosis membrane to be used in the osmosis membrane treatment process is not specifically limited, as long as it has ability to remove the impurities contained in the crude aqueous hydrogen peroxide solution.

Examples of the form of the reverse osmosis membrane include a flat membrane, a pleated membrane, a spiral membrane, a tube membrane, a rod membrane, a fine tube membrane, a spaghetti membrane, a hollow fiber membrane, or a combination thereof.

In the osmosis membrane treatment process, a reverse osmosis membrane device with a reverse osmosis membrane incorporated may be used and a cylindrical device with reverse osmosis membranes of various shapes incorporated may be used, for example. A reverse osmosis membrane device having a reverse osmosis membrane may be used alone, or a plurality thereof may be connected in series or in parallel for use. For example, two or more reverse osmosis membrane devices or ten or more reverse osmosis membrane devices may be connected in parallel.

### 2-2. Material of Reverse Osmosis Membrane

Examples of the material for the reverse osmosis membrane include polyethyleneimine condensate, cellulose acetate, modified polyacrylonitrile, polybenzimidapyrone, polyether amide, cellulose triacetate, polyamide carboxylic acid, crosslinked polyether, crosslinked polyamide, polyimide, polybenzimidazole, sulfonated phenylene oxide, polypiperazine amide, polyethyleneimintole, engineered isocyanate, polyethylene isinate chloride, sulfonated polyfurfuryl alcohol, sulfonated polysulfone, polyether urea, polyvinyl alcohol, polysulfone, polyamide polyvinyl alcohol, sulfonated polyether sulfone, or polyamide. The reverse osmosis membrane may be asymmetric or composite membrane. The reverse osmosis membrane is preferably a composite membrane made of polyamide.

As the material for the reverse osmosis membrane, it is preferable to use a material with a mass ratio of oxygen amount/nitrogen amount of less than 40. That is, the aforementioned ratio that corresponds to the weight ratio of oxygen atoms to nitrogen atoms in the material member forming the surface of the reverse osmosis membrane through which the aqueous hydrogen peroxide solution is permeated is preferably less than 40, more preferably less than 35, further preferably less than 25, less than 20, or less than 10, particularly preferably less than 2 such as 0.1 or more and less than 2.

Conventionally, it has been said that the RO membrane with the high oxygen/nitrogen ratio coated with polyvinyl alcohol (PVA) or the like can suppress the attachment of organic impurities, but polyvinyl alcohol may be decomposed by hydrogen peroxide. Therefore, for avoiding unnecessary decomposition on the membrane surface, it is preferable to employ an RO membrane whose surface is not coated with PVA, an RO membrane that satisfies the aforementioned requirement of oxygen/nitrogen ratio, or the like.

### 2-3. Properties of Reverse Osmosis Membrane

The reverse osmosis membrane preferably has a surface roughness average of 0.240 μm or more. Further, the surface roughness average of the reverse osmosis membrane is preferably 1.000 μm or less. It was confirmed that use of a reverse osmosis membrane having such an average roughness increases the TC blocking rate to permeated hydrogen peroxide, that is, efficiently reduces the TC value in permeated hydrogen peroxide.

The surface roughness average in the reverse osmosis membrane is more preferably 0.300 μm to 0.900 μm, further preferably 0.400 μm to 0.850 μm, particularly preferably 0.450 μm to 0.800 μm such as 0.500 μm to 0.750 μm. Generally, the initial value of the surface roughness of the RO membrane is often 0.600 to 0.700 μm, but the surface tends to become smoother and the surface roughness decreases with use. Therefore, it is important to check and adjust the average roughness of the reverse osmosis membrane.

The surface roughness of the reverse osmosis membrane is the value of the arithmetic roughness average Ra based on the JIS standard (JIS B 0601-2001).

The treatment pressure applied to the reverse osmosis membrane when bringing the crude aqueous hydrogen peroxide solution into contact with the reverse osmosis membrane may be within the range that the reverse osmosis membrane is tolerable. Preferably, the reverse osmosis membrane can withstand a pressure in the range of 0.02 to 8.0 (MPaG), which is applied to the crude aqueous hydrogen peroxide solution. Thus, the pressure range that can be applied to the reverse osmosis membrane is more preferably the aforementioned pressure range in the osmosis membrane treatment process or 0.10 to 7.0 (MPaG), further preferably 0.30 to 6.0 (MPaG), 0.50 to 5.0 (MPaG), or 1.0 to 4.5 (MPaG), for example.

Further, the tolerable pressure (absolute pressure: MPaA (or MPa)) of the reverse osmosis membrane is preferably 0.12 to 8.1 (MPaG), more preferably 0.20 to 7.1 (MPa), further preferably 0.40 to 6.1 (MPa), 0.60 to 5.1 (MPa), or 1.1 to 4.6 (MPa), for example.

As the reverse osmosis membrane, it is preferable to use a reverse osmosis membrane in which the permeation flux of pure water when the temperature is 25° C., and the effective pressure is 2.0 MPa can be adjusted to less than 0.6 (m³/m²/day). Specifically, it is preferable to use a reverse osmosis membrane that allows pure water to permeate therethrough at a permeation flux of 0.1 or more and less than 0.6 (m³/m²/day), 0.2 or more and less than 0.6 (m³/m²/day), or 0.3 or more and 0.5 (m³/m²/day) or less.

The aforementioned temperature is the temperature of pure water that permeates through the reverse osmosis membrane and the reverse osmosis membrane itself. Further, the effective pressure is the effective pressure acting on the reverse osmosis membrane, obtained by subtracting the osmotic pressure difference and the secondary side pressure from the average operation pressure, and the average operation pressure is the average of the pressure of supply water (operating pressure) and the pressure of concentrated water (concentrated water outlet pressure) on the primary side of the reverse osmosis membrane (i.e., (operating pressure+concentrated water outlet pressure)/2).

As the reverse osmosis membrane, it is preferable to use a reverse osmosis membrane having a water permeability of 300 to 1000 GPD (Gallons per day) under conditions at a supply water temperature of 25° C., a supply pressure of 5.5 MPa, and a salinity concentration of supply water of 32000 (ppm (mg/L)). The water permeability of the reverse osmosis membrane is more preferably 400 to 800 GPD, further preferably 500 to 700 GPD, particularly preferably 550 to 650 GPD.

The RO membrane can be used by being incorporated into a reverse osmosis membrane module. The reverse osmosis membrane module may comprise a reverse osmosis membrane and a pressure-resistant container that fixedly supports the reverse osmosis membrane, and may further comprise a pressurizing means for bringing the crude aqueous hydrogen peroxide solution into contact with the reverse osmosis membrane.

The membrane area in the reverse osmosis membrane, that is, the area of the permeation surface of the crude aqueous hydrogen peroxide solution in the reverse osmosis membrane is not particularly limited. For example, the membrane area of the reverse osmosis membrane included in one actual scale device (such as one with a total length of about 8 inch) is about 40 m².

### 3. Roughness Measurement Step

The method for producing a purified aqueous hydrogen peroxide solution preferably further comprises a roughness measurement step of measuring the surface roughness of the reverse osmosis membrane used in the osmosis membrane treatment process. As described above, since the surface roughness of the RO membrane generally decreases with use in the osmosis membrane treatment process, whether or not the surface roughness average is adjusted to the preferable range is confirmed by the roughness measurement step.

The surface roughness of the reverse osmosis membrane is preferably measured or at least confirmed, by documentation, for example, before and after the osmosis membrane treatment process or before the osmosis membrane treatment process. Further, measuring the surface roughness of the reverse osmosis membrane after use in the osmosis membrane treatment process, preferably, immediately after the osmosis membrane treatment is advantageous in that the degree of deterioration of the reverse osmosis membrane in the osmosis membrane treatment, the relationship between the concentration of the impurities (TC value) in crude hydrogen peroxide or permeated hydrogen peroxide and the surface roughness becomes clear. Therefore, measuring the surface roughness of the reverse osmosis membrane after the osmosis membrane treatment process enables the time for subsequent replacement of the reverse osmosis membrane to be predicted and the occurrence of defects in the osmosis membrane treatment process to be preliminarily prevented.

The surface roughness of the RO membrane is measured using a three-dimensional white light interference microscope, an atomic force microscope (AFM), or the like.

### [Purification System of Aqueous Hydrogen Peroxide Solution]

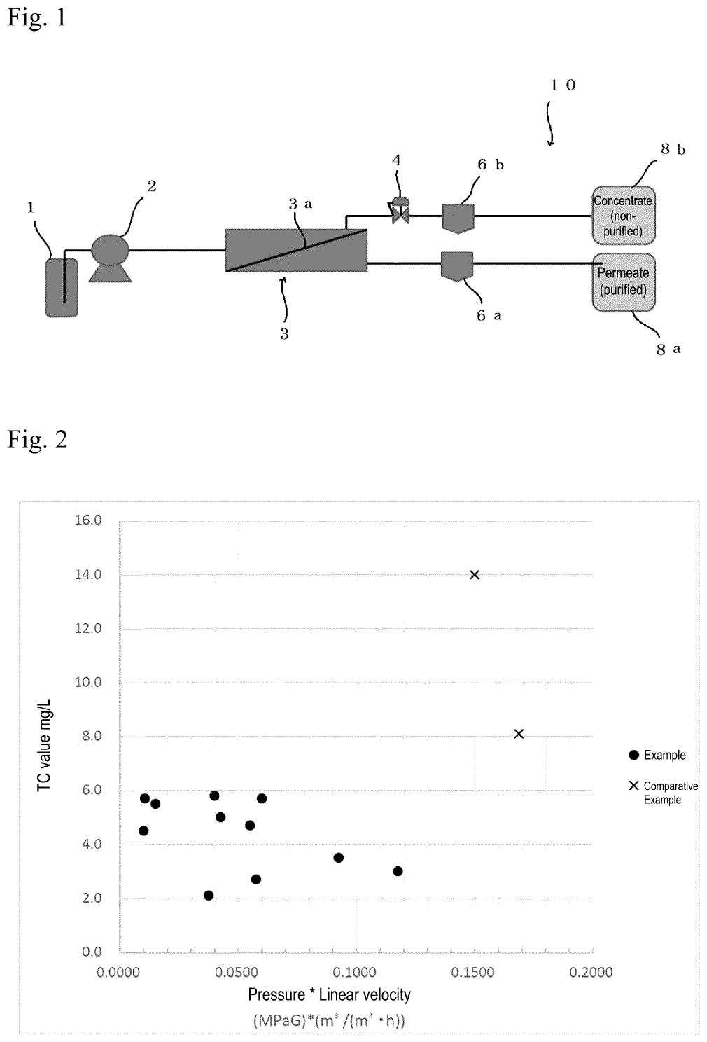

FIG. 1 is a schematic view showing an example of a purification system 10 of an aqueous hydrogen peroxide solution that can be used in the osmosis membrane treatment process for purifying the aqueous hydrogen peroxide solution. The purification system 10 comprises an RO membrane vessel 3 or the like, and the RO membrane vessel 3 is provided with an RO membrane 3a. In the purification system 10, a tank 1 for raw material hydrogen peroxide (crude aqueous hydrogen peroxide solution, which is hereinafter referred to also as crude hydrogen peroxide), a metering pump 2, the RO membrane vessel 3, a back pressure valve 4, first and second flow sensors 6a and 6b, purification side, non-purification side treated liquid tanks 8a and 8b are connected with pipes, as shown in the figure.

The crude hydrogen peroxide is separated into permeate (permeated hydrogen peroxide) sent to the purification side treated liquid tank 8a and a concentrate (concentrated hydrogen peroxide) sent to the non-purification side treated liquid tank 8b and purified by an RO membrane 3a disposed inside the RO membrane vessel 3, as described below.

In the purification process of the aqueous hydrogen peroxide solution by the purification system 10, a predetermined raw material hydrogen peroxide is first put into a raw material hydrogen peroxide tank 1, and then the liquid temperature is adjusted to a predetermined temperature (for example, the temperature shown in Tables below showing the results of Examples (such as 20° C.)) with a chiller/heater. After the raw material hydrogen peroxide is fed to the RO membrane vessel 3 side with a metering pump 2, and the circulation of hydrogen peroxide to the pipe on the concentrate side is confirmed, the back pressure valve 4 connected to the pipe on the concentrate side is gradually tightened, and then the inside of the RO membrane vessel 3 is pressurized to a predetermined pressure (for example, the pressure shown in Tables below showing the results of Examples (such as up to 2.20 MPaG)). Then, when the osmotic pressure of the crude hydrogen peroxide inside the RO membrane vessel 3 exceeds the predetermined pressure, hydrogen peroxide starts circulating in the pipe on the permeate side.

Substantially only the hydrogen peroxide and water are permeated into the pipe on the permeate side with respect to the RO membrane vessel 3, and the crude hydrogen peroxide is purified. Meanwhile, the hydrogen peroxide solution containing impurities is sent to the pipe on the non-permeate side with respect to the RO membrane vessel 3. The ratio of these permeates, that is, the ratio of the amount of permeate that permeates through the pipe on the permeate side to the amount of permeate that permeates through the pipe on the non-permeate side is controlled by monitoring each flow rate with a first flow sensor 6a on the pipe on the permeate side and a second flow sensor 6b on the pipe on the non-permeate side and adjusting the back pressure valve 4 to predetermined flow rates. The back pressure valve 4 is adjusted, for example, so that the concentrate (non-permeate) is 0.5 L/min, and the permeate is 0.5 L/min, when the raw material pump flow rate is 1.00 L/min and the permeation ratio is 50%. In this way, the hydrogen peroxide solution is collected while maintaining the predetermined permeate/concentrate flow ratios.

Hereinafter, the present invention will be described more specifically by way of Examples, but the present invention is not limited to these Examples.

### EXAMPLES

### [Analysis/Measurement Method]

### <Treatment Pressure Applied to Reverse Osmosis Membrane (Pressure of Reverse Osmosis Membrane (MPaG))>

Using a Bourdon tube pressure gauge, the pressure of the reverse osmosis membrane (MPaG) was measured.

<Linear Velocity of Aqueous Hydrogen Peroxide Solution (m³/(m²·h))>

The flow rate of permeated hydrogen peroxide in formula (1) below and the area of the RO membrane were measured, and the linear velocity of the aqueous hydrogen peroxide solution was calculated based on formula (1) below.

$$Linear velocity ( {m}^{3} / ( {m}^{2} \cdot h ) ) = flow rate of \text{} permeated \text{} hydrogen peroxide ( {m}^{3} / h ) / area of RO membrane ( {m}^{2} ) \qquad ( 1 )$$

<Viscosity (mPa·s) of Crude Aqueous Hydrogen Peroxide Solution>

Using a BII-type viscometer (available from TOKI SANGYO CO., LTD.), the viscosity (mPa·s) of the crude aqueous hydrogen peroxide solution was measured.

### <Tc Value>

For measuring a TOC concentration (TC value) showing the amount of organic compounds in the aqueous hydrogen peroxide solution after purification, the following device and method were used.

A TOC value was measured using a TOC (total organic carbon) meter, to determine a TC value.

Device: TOC-L, available from SHIMADZU CORPORATION
Measurement method: Each sample was heated to 680° C. in the presence of a platinum catalyst in a combustion furnace filled with purified air to combust, decompose, and convert into carbon dioxide. The converted carbon dioxide was cooled and dehumidified, and the TC (total carbon) concentration in the sample was determined by comparison with a calibration curve. Thereafter, the same sample was separately acidified and aerated to convert IC (inorganic carbon) in the sample into carbon dioxide, which was detected to determine the IC concentration. The TOC concentration was calculated by subtracting the IC concentration from the determined TC concentration.

### <Purification by RO Membrane>

As an RO membrane, a commercially available 582GPD reverse osmosis membrane was used. Then, conditions such as permeation ratio (collection ratio), feed liquid temperature, feed liquid flow rate, and processing pressure were set as shown in Table 1 below, and the aqueous hydrogen peroxide solution was purified.

### <Surface Roughness of RO Membrane>

The surface roughness of the RO membrane was measured using a three-dimensional white light interference microscope as follows.

Device: “Contour GT-K”, available from Bruker Japan K.K.

Each sample of the RO membrane was cut out into about 2 cm square, and it was set on a slide glass of the device and subjected to analysis while being moistened with water.

Device: Contour GT-K, available from Bruker Japan K.K.
Measurement mode: Vertical scanning (VSI)
Objective lens: 50 times
Measurement range: (XY) 126×95 μm² (Z) 30 μm

### BackScan: 5 μm

Threshold: 5% (CCD detector sensitivity threshold)
Correction: Cylindrical+tilt correction
Measurement method: The measurement was carried out in a mode in which interference fringes were measured by scanning 30 μm in the Z direction while applying white light on the sample of the RO membrane.

### <Foaming of Aqueous Hydrogen Peroxide Solution>

50 ml of the purified aqueous hydrogen peroxide solution was added in a 50 ml volumetric flask and heated in a boiling bath for 5 hours. Thereafter, the aqueous solution was cooled to room temperature, and foaming was visually determined when it was subjected to a ultrasonic cleaner to be degassed. Those with no foaming observed were determined to be “good”, and those with foaming observed were determined to be “defective”.

### <Odor of Aqueous Hydrogen Peroxide Solution>

The purified aqueous hydrogen peroxide solution was weighed out in a 50 ml volumetric flask, a stopper was put thereon. After shaking for 10 times, the odor was determined by the operator's sense of smell. Those with no odor sensed were determined to be “good”, and those with odor sensed were determined to be “defective”.

### Example 1

A 45% hydrogen peroxide solution (unwashed crude hydrogen peroxide) prepared from hydrogen peroxide obtained by the anthraquinone method was purified with the RO membrane in the conditions shown in Table 1 below. As an RO membrane, a commercially available product having a membrane area of 2.4 (m²), a surface average roughness of 0.60 μm, a permeation flux of pure water under conditions at a temperature of 25° C. and an effective pressure of 2.0 MPa of 0.5 (m³/m²/day), and a mass ratio of the amount of oxygen/the amount of nitrogen of less than 2 was used. Then, Table 1 shows the results of the TOC concentration (TC concentration), foaming evaluation, and odor evaluation of the purified aqueous hydrogen peroxide (permeated hydrogen peroxide) solution obtained.

TABLE 1

| | | | | | | | Pressure * Linear |
|---|---|---|---|---|---|---|---|
| | | | Linear | Flow | | | velocity |
| | Permeation | Temperature | velocity | rate | Pressure | Viscosity | (MPaG)*(m³/ |
| | ratio (%) | (° C.) | (m³/(m² · h)) | (L/min) | (MPaG) | (cP) | (m² · h)) |
| Example 1 | 25 | 10.0 | 0.025 | 1.00 | 1.50 | 1.46 | 0.0375 |
| Example 2 | 30 | 10.0 | 0.025 | 1.00 | 2.30 | 1.46 | 0.0575 |
| Example 3 | 50 | 10.0 | 0.025 | 1.00 | 4.70 | 1.46 | 0.1175 |
| Example 4 | 50 | 10.0 | 0.025 | 1.00 | 3.70 | 1.46 | 0.0925 |
| Example 5 | 25 | 20.0 | 0.025 | 1.00 | 0.40 | 1.17 | 0.0100 |
| Example 6 | 50 | 20.0 | 0.025 | 1.00 | 1.70 | 1.17 | 0.0425 |
| Example 7 | 70 | 20.0 | 0.025 | 1.00 | 2.40 | 1.17 | 0.0600 |
| Example 8 | 70 | 20.0 | 0.025 | 1.00 | 2.20 | 1.17 | 0.0550 |
| Example 9 | 70 | 20.0 | 0.013 | 0.50 | 1.20 | 1.17 | 0.0150 |
| Example 10 | 25 | 30.0 | 0.025 | 1.00 | 0.42 | 0.94 | 0.0105 |
| Example 11 | 70 | 30.0 | 0.025 | 1.00 | 1.60 | 0.94 | 0.0400 |
| Comparative Example 1 | 70 | 10.0 | 0.025 | 1.00 | 6.00 | 1.46 | 0.1500 |
| Comparative Example 2 | 70 | 20.0 | 0.038 | 1.50 | 4.50 | 1.17 | 0.1688 |

| | | Pressure * Linear | | | |
|---|---|---|---|---|---|
| | | velocity * | | | |
| | Pressure/ | Viscosity | TC | | |
| | Temperature | (MPaG)*(m³/ | Value | | |
| | (MPaG)/(° C.) | (m² · h))*cP | (mg/L) | Foaming | Odor |
| Example 1 | 0.150 | 0.055 | 2.1 | Good | Good |
| Example 2 | 0.230 | 0.084 | 2.7 | Good | Good |
| Example 3 | 0.470 | 0.172 | 3.0 | Good | Good |
| Example 4 | 0.370 | 0.135 | 3.5 | Good | Good |
| Example 5 | 0.020 | 0.012 | 4.5 | Good | Good |
| Example 6 | 0.085 | 0.050 | 5.0 | Good | Good |
| Example 7 | 0.120 | 0.070 | 5.7 | Good | Good |
| Example 8 | 0.110 | 0.064 | 4.7 | Good | Good |
| Example 9 | 0.060 | 0.017 | 5.5 | Good | Good |
| Example 10 | 0.014 | 0.010 | 5.7 | Good | Good |
| Example 11 | 0.053 | 0.038 | 5.8 | Good | Good |
| Comparative Example 1 | 0.600 | 0.219 | 14.0 | Defective | Defective |
| Comparative Example 2 | 0.225 | 0.197 | 8.1 | Defective | Defective |

### Examples 2 to 11 and Comparative Examples 1 and 2

The same 45% hydrogen peroxide solution (unwashed crude hydrogen peroxide) as in Example 1 was purified under the conditions of Table 1 above.

For example, in Example 7, the back pressure valve 4 was adjusted to a raw material pump flow rate of 1.00 L/min, a concentrate (non-permeate) flow rate of 0.3 L/min, and a permeate flow rate of 0.7 L/min, in order to achieve a permeation ratio of 70%. Further, in Example 7, in order to achieve a linear velocity, that is, a value obtained by dividing the raw material pump flow rate by the membrane area of 0.025 (m³/(m²·h), an RO membrane having a flow rate of 1.00 L/min and a membrane area of 2.4 (m²) was used, and a raw material hydrogen peroxide (crude aqueous hydrogen peroxide solution, hydrogen peroxide) with a viscosity of 1.17 (mPa·s) was targeted for purification.

In Examples 8 and 9 and Comparative Example 1, the same product as the RO membrane used in other Examples such as Example 7, but the surface roughness was small since it had been used over a long period of time, was used. Table 2 shows the average roughness on the surface of the RO membrane.

TABLE 2

| | Surface roughness (μm) | TC value (mg/L) |
|---|---|---|
| Example 7 | 0.600 | 5.7 |
| Example 8 | 0.558 | 4.7 |
| Example 9 | 0.480 | 5.5 |
| Comparative Example 1 | 0.230 | 14.0 |

As obvious from the results of Examples and Comparative Examples shown in Table 1, the occurrence of foaming and odor was suppressed by controlling the purification conditions of the crude hydrogen peroxide, while sufficiently reducing the TC value of the purified hydrogen peroxide solution to be obtained.

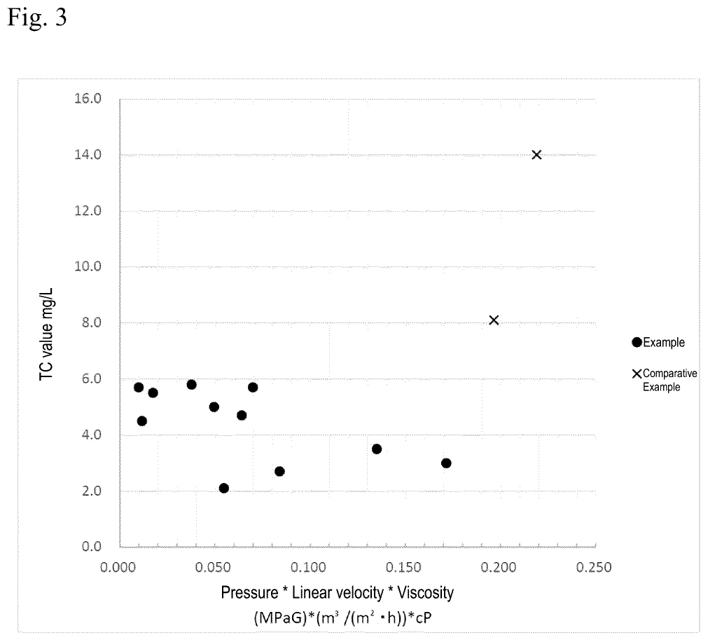

Specifically, the TC value was sufficiently reduced in Examples in which the first integrated value that is the integrated value of the pressure of reverse osmosis membrane (MPaG) and the linear velocity of the aqueous hydrogen peroxide solution (m³/(m²·h)) was less than 0.15, as compared to Comparative Examples that do not satisfy those requirements, and it was confirmed from the results of Table 1 and FIG. 2 that the occurrence of foaming and odor was prevented, and impurities such as organic compounds were efficiently removed. Also, in Examples in which the second integrated value obtained by further multiplying the first integrated value by the viscosity (mPa·s) of the crude aqueous hydrogen peroxide solution was less than 0.19, it was demonstrated from the results of Table 1 and FIG. 3 that the crude hydrogen peroxide could be effectively purified.

From the results of Examples 7 to 9 and Comparative Example 1 shown in Table 2, the TC value was sufficiently reduced, and good results were shown in Examples in which RO membranes having a surface roughness of about 0.480 μm to 0.600 μm were used, even if the purification conditions other than the surface roughness of the RO membrane were not completely the same (see Table 1), whereas the TC value was high in Comparative Example 1 in which an RO membrane with excessively low surface roughness was used, and there was a tendency that the concentration of impurities in the permeated hydrogen peroxide could not be sufficiently reduced.

### REFERENCE SIGNS LIST

3: RO membrane vessel
3a: RO membrane
10: Purification system (purification system of aqueous hydrogen peroxide solution)

1. A method for producing a purified aqueous hydrogen peroxide solution, the method comprising an osmosis membrane treatment process of bringing a crude aqueous hydrogen peroxide solution containing impurities into contact with a reverse osmosis membrane, wherein:
a pressure of the reverse osmosis membrane (MPaG) and a linear velocity of the aqueous hydrogen peroxide solution (m³/(m²·h)) are adjusted so that a first integrated value that is an integrated value of the pressure and the linear velocity is less than 0.15, in the osmosis membrane treatment process.

2. The method according to claim 1, wherein a surface roughness average of the reverse osmosis membrane is 0.24 μm or more.

3. The method according to claim 1, wherein a surface roughness average of the reverse osmosis membrane is 1.0 μm or less.

4. The method according to claim 1, wherein a weight ratio of oxygen/nitrogen on a surface of the reverse osmosis membrane is less than 40.

5. The method according to claim 1, further comprising measuring a surface roughness of the reverse osmosis membrane to be used in the osmosis membrane treatment process.

6. The method according to claim 1, wherein a second integrated value obtained by further multiplying the first integrated value by a viscosity (mPa·s) of the crude aqueous hydrogen peroxide solution in the osmosis membrane treatment process is less than 0.19.

7. The method according to claim 1, wherein a temperature of the crude aqueous hydrogen peroxide solution is 10 to 30° C. in the osmosis membrane treatment process.

8. The method according to claim 1, wherein a permeation ratio (%), as defined by formula (1) below, of permeated hydrogen peroxide that is in an aqueous hydrogen peroxide solution in which impurities are reduced, and concentrated hydrogen peroxide that is in an aqueous hydrogen peroxide solution which does not permeate through the reverse osmosis membrane and in which impurities are concentrated, to be obtained by the osmosis membrane treatment process, is 80% or less:
permeation ratio (%)=(mass of permeated hydrogen peroxide)/(mass of permeated hydrogen peroxide+concentrated hydrogen peroxide)×100 (1).

9. The method according to claim 8, wherein:
the permeation ratio is 40% or less, and
a temperature of the crude aqueous hydrogen peroxide solution in the osmosis membrane treatment process is 25° C. or less.

10. The method according to claim 8, wherein;
the permeation ratio is 60% or more, and
a temperature of the crude aqueous hydrogen peroxide solution in the osmosis membrane treatment process is 15 to 35° C.
